(19) United States
(12) Patent Application Publication
(10) Pub. No.: US 2009/0243865 A1
(43) Pub. Date: Oct. 1, 2009

(54) Shake awake mattress (S.A.M.)

(76) Inventor: AARON ROBERT LEMA, MORENO VALLEY, CA (US)

Correspondence Address: AARON LEMA, 24617 JASMINE COURT, MORENO VALLEY, CA, 92557, US

(21) Appl. No.: 12/079,123

(22) Filed: Mar. 25, 2008

(51) Int. Cl. G08B 17/10

(52) U.S. Cl. 340/628

(57) ABSTRACT

A fire alarm attached to a bed for arousing sleeping deaf or hearing impaired people that consists of: a fire, smoke and carbon monoxide alarm, a secondary alarm featuring a phone jack for dialing emergency services and digital display of the type of emergencies taking place to be read by the deaf or hearing impaired as well as a motorized alarm unit that attaches to the head of the bed providing a lifting and dropping motion to arouse sleeping deaf or hearing impaired people.

### FIELD OF INVENTION

The invention pertains to fire, smoke and carbon monoxide systems. More particularly, the invention pertains to detectors incorporating visual and audible alarm features.

The invention pertains to motorized and adjustable beds. More particularly, the invention pertains to motorized or adjustable beds incorporating an electric motor.

### BRIEF SUMMARY OF THE INVENTION

While known fire, smoke and carbon monoxide alarms have been effective for their intended purposes, there is a need for alarms incorporating physical movements. The addition of physical movements to an alarm will benefit those with hearing impairments and the deaf by notifying them of emergencies detected by the alarm.

While known motorized and adjustable beds have been effective for their intended purpose, there is a need for incorporating fire, smoke and carbon monoxide alarms. The addition of fire, smoke and carbon monoxide alarms to a motorized bed will benefit those with hearing impairments and the deaf by arousing them from sleep when an emergency is detected.

### BRIEF DESCRIPTION OF THE DRAWINGS

FIG. 1 Placement of a Motorized Alarm Unit on top support rail of Frame Structure.

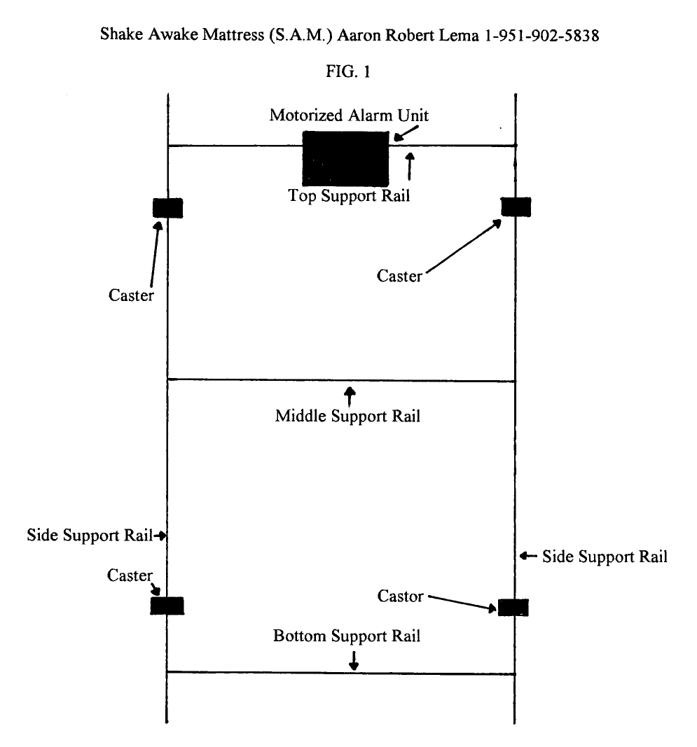

FIG. 2 Placement of a Motorized Alarm

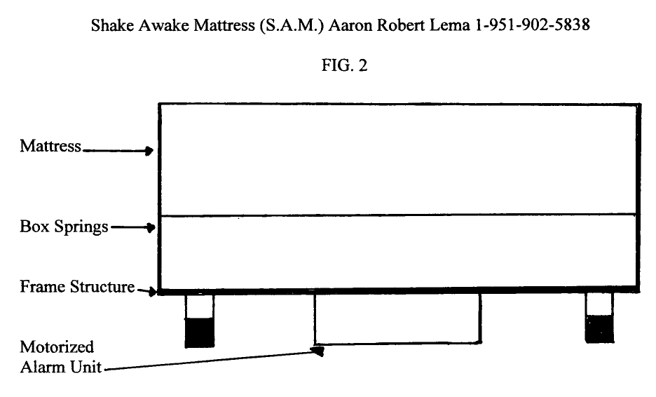

FIG. 3 Motorized Alarm Unit lifting head of Mattress, Box Springs and Frame Structure.

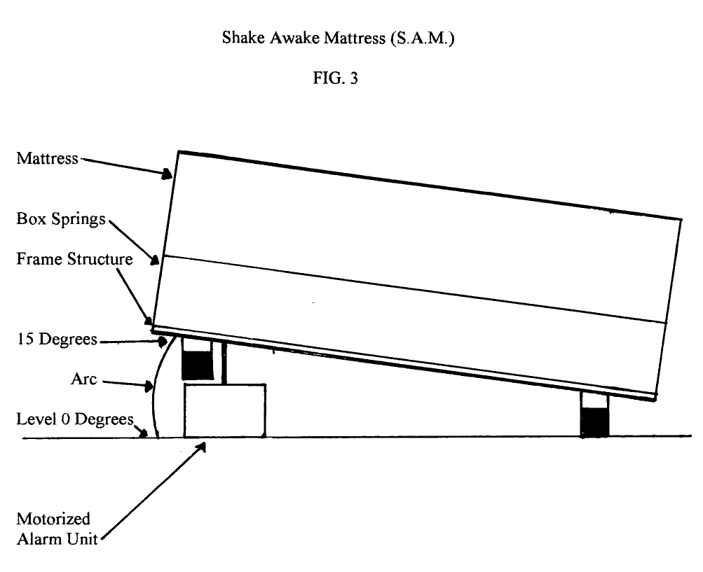

### DESCRIPTION OF THE INVENTION

Provided herein are methods and systems for a Shake Awake Mattress (S.A.M.)

A Shake Awake Mattress (S.A.M.) apparatus disclosed herein includes a motorized alarm unit, alarm unit, secondary alarm unit, box springs, mattress and bed frame structure consisting of: two side support rails with two casters each, top support rail, middle support rail, bottom support rail and at least one motorized alarm unit connected to the top support rail; wherein the at least one motorized alarm unit may be used to lift and drop the frame, bed, box springs and matters. The motor may be selected from a list including at least an electric actuator motor, a pneumatic actuator motor, a magnetic actuator motor or hydraulic actuator motor and a motorized adjustable bed.

An apparatus disclosed herein includes a secondary alarm unit that may include at least an external power supply cord, a flashing digital display of the words fire, smoke and carbon monoxide: a manual shutoff switch for the actuator motor, a alarm test button, a phone jack, a clock and battery backup power supply. In addition the secondary alarm unit will contain an internal computer device to access commands from the alarm unit, send commands to the actuator motor, dial the emergency services, store the pre recorded message to be sent over phone to emergency services, control the clock functions, control the digital display warnings and monitor the back up power supply. The secondary alarm unit's internal computer device may be selected from a list including at least a microcontroller, a microcomputer, a (PLC) or programmable logic circuit and a logic circuit (LC). The secondary alarm unit may be selected from a list including at least an alarm clock, a personal computer, an audio/visual device, a telephone, a music player, a DVD player, CD player and a TV.

An apparatus disclosed herein includes an alarm unit that may include at least an internal computer device, fire alarm with back up power supply and audible/visual warning signals, smoke detector with back up power supply and audible/visual warning signals and carbon monoxide detector with back up power supply audible/visual warning signals. Audible warning signals can include beeps, buzzes and high pitched tones. Visual warning signals can include bright flashing lights.

An apparatus disclosed herein includes a motorized alarm unit device that may include at least an internal computer device, electric actuator motor, a pneumatic actuator motor, a magnetic actuator motor and a hydraulic actuator motor. The motorized alarm unit uses the actuator motor to push against the bed, bed frame, box springs or adjustable bed frame in an upward and downward, side to side or vibrating motion. It is required for such an actuator motor to be small since space beneath a bed, bed frame, box springs, motorized bed and adjustable bed is limited. It is required for a small actuator motor to have increased power output as weight of bed, bed frame, box springs, adjustable beds and occupants will vary from light to heavy loads.

A method and system disclosed herein includes providing an bed, bed frame, box springs, motorized bed or adjustable bed with at least one motorized alarm unit, one secondary alarm unit and one alarm unit; associating a motorized alarm unit to a secondary alarm unit and an alarm unit; wherein the motorized alarm unit receives control commands from the secondary alarm unit; and the secondary alarm unit receives commands from the alarm unit; and connecting the motorized alarm unit to the secondary alarm unit and the alarm unit; wherein the motorized alarm unit may be controlled by the secondary alarm unit and the secondary alarm unit may be controlled by the alarm unit.

A method and system disclosed herein includes providing communication capabilities to an alarm unit, secondary alarm unit and motorized alarm unit; associating communication capabilities between an alarm unit, secondary alarm unit and an motorized alarm unit; wherein the motorized alarm unit communicates with the secondary alarm unit: and the secondary alarm unit communicates with the alarm unit; and connecting communication capability between the motorized alarm unit to the secondary alarm unit and the alarm unit: wherein the motorized alarm unit may communicate with the secondary alarm unit and the secondary alarm unit may communicate with the alarm unit. The communication signals can be sent or received from or too a motorized alarm unit, a secondary alarm unit and an alarm unit. The communication signal can be selected from a list including at least a Bluetooth wireless specification, an ultra-wideband (UWB) wireless specification, a wireless USB specification, a cellular specification, a radio frequency (RF) and plug and wire.

A method and system disclosed herein includes providing internal computer devices to an alarm system, secondary alarm system and motorized alarm system comprising; communication soft ware, command control soft ware, emergency detection software, message recording soft ware. The internal computers hardware may be selected from a list including at least a: microcontroller, a micro computer, a (PLC) a programmable logic circuit and a logic circuit (LC).

A method and system disclosed herein includes providing a physical alarm consisting of an: motorized alarm unit with lifting and dropping motion: wherein the arc range of lifting motion is level or 0 degrees to a maximum of 15 degrees of vertical lift: wherein the arc dropping motion is 15 degrees of lift to a maximum of 0 degrees or level; wherein the bed, bed frame, box springs, motorized bed or adjustable bed is lifted and dropped at the top or head section leaving the tail or foot section stationary providing a arc range of vertical motion between 0 and 15 degrees.

A method and system disclosed herein includes providing a physical alarm to a sleeping deaf or hearing impaired person; wherein the alarm unit detects emergency; wherein the alarm unit communicates emergency to secondary alarm unit; wherein secondary alarm unit relays emergency over phone line to emergency services, communicates nature of alarm on digital screen and communicates emergency to motorized alarm unit; wherein motorized alarm unit lifts and drops frame structure, box springs and mattress providing the physical alarm needed to arouse a sleeping deaf or hearing impaired person.

The primary power source for the secondary alarm unit and motorized alarm unit is AC power, with plug and wiring connecting units to host AC power.

The primary power source for the alarm unit is AC power with direct wiring to host electrical circuitry.

The backup power supply for the alarm unit, secondary alarm unit and motorized alarm unit are battery packs containing one or more rechargeable or disposable batteries with sufficient power to power each unit in the event AC power is interrupted.

An automatic power-switching unit is incorporated into each individual unit to switch the power source from AC power to backup power supply in the event of an interruption. Likewise, if power is restored the automatic power-switching unit will switch back AC power from battery backup.

Those of skill will understand that variations in the above described processing's could be implemented without departing from the scope and spirit of the present invention. For example, one or more detection devices could be incorporated into the alarm unit; one or more actuator motors can be incorporated into the motorized alarm unit; one or more of the features incorporated into the secondary alarm unit can be incorporated into the secondary alarm unit; one or more of the independent units of the invention can be incorporated into the invention. Other forms of detectors indicating a dangerous condition could also be incorporated into the alarm unit and secondary alarm unit without departing from the scope and spirit of the present invention.

From the forgoing, it is understood and observed that numerous modifications and variations may be incorporated without departing from the scope and spirit of the invention. It is to be understood that no limitations with regard to specific apparatus illustrated herein is intended or should be inferred. It is of course intended to cover by appended claims all such modifications as fall within the scope and spirit of the claims.

What is claimed:

1. A Shake Awake Mattress providing warnings of multiple types of emergency situations in an visual, audio and physical means comprising: a connector for connecting the alarm unit, secondary alarm unit and motorized alarm unit; a connector for connecting the alarm units and motorized alarm unit to host electricity; a backup power source; a bed, bed frame, box springs or adjustable bed, motorized bed and a phone jack.

2. The alarm unit of claim 1, installed in a residence or commercial facility wherein the connector connects the unit to host electricity.

3. The alarm unit of claim 1, wherein the backup power source is one or more disposable or rechargeable batteries.

4. The alarm unit of claim 1, wherein the emergency situations include any combination of fire, smoke or carbon monoxide gas leak.

5. The alarm unit of claim 1, wherein the audio alarm includes beeps or high pitched tones.

6. The alarm unit of claim 1, wherein the visual alarm includes flashing lights.

7. The secondary alarm unit of claim 1, installed in a residence or commercial facility wherein the connector connects the unit to host electricity.

8. The secondary alarm unit of claim 1, wherein the backup power source is one or more disposable or rechargeable batteries.

9. The secondary alarm unit of claim 1, wherein the phone connector connects the unit to host phone lines.

10. The secondary alarm unit of claim 1, wherein the audio alarm includes beeps or high pitched tones.

11. The secondary alarm unit of claim 1, wherein the visual alarm includes flashing lights and digital displays of words.

12. The motorized alarm unit of claim 1, installed in a residence or commercial facility wherein the connector connects the unit to host electricity.

13. The motorized alarm unit of claim 1, wherein the back up power source is one or more disposable or rechargeable batteries.

14. The motorized alarm unit of claim 1, wherein the actuator motor is incased in a housing, attached to a bracket or fastened to a mounting plate.

15. The motorized alarm unit of claim 1, wherein the physical alarm includes lifting, dropping, pulsating or vibrating of the bed, bed frame, adjustable bed or box springs.

16. The motorized alarm unit of claim 1, wherein the electric, pneumatic, magnetic or hydraulic actuator motor connected to the bed, bed frame or box springs provides a lifting and dropping, side to side or vibrating motion.

17. The motorized alarm unit of claim 1, wherein at least one bracket, brace, hinge, metal pin or removable coupling is attached to the motor and bed, bed frame or box spring.

18. The motorized alarm unit of claim 1, further comprising a second bracket, brace, hinge, metal pin or removable coupling coupled to the bed, bed frame, or box springs working cooperatively with a second bracket, brace, hinge, metal pin or removable coupling coupled to the actuator motor.

19. The motorized alarm unit of claim 1, wherein removing at least one bracket, brace, hinge, metal pin or removable coupling will facilitate servicing, removing or replacing the actuator motor.
